(19) United States
(12) Patent Application Publication
(10) Pub. No.: US 2023/0356484 A1
(43) Pub. Date: Nov. 9, 2023

(54) A METHOD OF MANUFACTURING A WIND TURBINE BLADE PART WITH A FLOW-ENHANCING MAT

(71) Applicant: LM WIND POWER A/S, Kolding (DK)

(72) Inventors: Morten Bak BRINK, Kolding (DK); Lars NIELSEN, Kolding (DK); Klavs JESPERSEN, Kolding (DK); Michael KOEFOED, Kolding (DK); Jens Zangenberg HANSEN, Kolding (DK); Henrik BARSLEV, Kolding (DK)

(21) Appl. No.: 18/029,430

(22) PCT Filed: Oct. 8, 2021
(86) PCT No.: PCT/EP2021/077901

§ 371 Date: Mar. 30, 2023

(30) Foreign Application Priority Data
Oct. 9, 2020 (GB) 2016044.6

(51) Int. Cl. B29C 70/54; B29C 70/12; B29C 70/48; B29C 71/00

(52) U.S. Cl. CPC B29C 70/547; B29C 70/12; B29C 70/541; B29C 70/48; B29C 71/00; B29L 2031/7504

(57) ABSTRACT

A method of manufacturing a wind turbine blade part, such as a spar cap, by means of resin transfer moulding, preferably vacuum assisted resin transfer moulding, where fibre reinforcement material is impregnated with liquid resin in a mould cavity, wherein the mould cavity includes a rigid mould part having a mould surface defining a surface of the wind turbine blade part is described. The method includes the steps of: a) stacking a plurality of fibre reinforcement layers on the rigid mould part forming a fibre reinforcement stack, b) providing at least one flow-enhancing mat in the fibre reinforcement stack, c) sealing a second mould part, against the rigid mould part to form the mould cavity, d) optionally evacuating the mould cavity, e) supplying a resin to the mould cavity, and f) curing or hardening the resin in order to form the wind turbine blade part.

### FIELD OF THE INVENTION

The present invention relates to a method of manufacturing a wind turbine blade part, a spar cap manufactured according to the method, and a flow enhancing mat for use in a method of manufacturing wind turbine blade part.

### BACKGROUND OF THE INVENTION

Wind turbine blades are often manufactured according to one of two constructional designs, namely a design where a thin aerodynamic shell is glued onto a spar beam, or a design where spar caps, also called main laminates, are integrated into the aerodynamic shell.

In the first design, the spar beam constitutes the load-bearing structure of the blade. The spar beam as well as the aerodynamic shell or shell parts are manufactured separately. The aerodynamic shell is often manufactured as two shell parts, typically as a pressure side shell part and a suction side shell part. The two shell parts are glued or otherwise connected to the spar beam and are further glued to each other along a leading edge and a trailing edge of the shell parts. This design has the advantage that the critical load-carrying structure may be manufactured separately and therefore easier to control. Further, this design allows for various different manufacturing methods for producing the beam, such as moulding and filament winding.

In the second design, the spar caps or main laminates are integrated into the shell and are moulded together with the aerodynamic shell. The main laminates typically comprise a high number of fibre layers compared to the remainder of the blade and may form a local thickening of the wind turbine shell, at least with respect to the number of fibre layers. Thus, the main laminate may form a fibre insertion in the blade. In this design, the main laminates constitute the load-carrying structure. The blade shells are typically designed with a first main laminate integrated in the pressure side shell part and a second main laminate integrated in the suction side shell part. The first main laminate and the second main laminate are typically connected via one or more shear webs, which for instance may be C-shaped or I-shaped. For very long blades, the blade shells further along at least a part of the longitudinal extent comprise an additional first main laminate in the pressure side shell, and an additional second main laminate in the suction side shell. These additional main laminates may also be connected via one or more shear webs. This design has the advantage that it is easier to control the aerodynamic shape of the blade via the moulding of the blade shell part.

Vacuum infusion or VARTM (vacuum assisted resin transfer moulding) is one method, which is typically employed for manufacturing composite structures, such as wind turbine blades comprising a fibre-reinforced matrix material.

During the process of filling the mould, a vacuum, said vacuum in this connection being understood as an under-pressure or negative pressure, is generated via vacuum outlets in the mould cavity, whereby liquid polymer is drawn into the mould cavity via the inlet channels in order to fill said mould cavity. From the inlet channels, the polymer disperses in all directions in the mould cavity due to the negative pressure and inter alia towards the vacuum channels. Thus, it is important to position the inlet channels and vacuum channels optimally in order to obtain a complete filling of the mould cavity. Ensuring a complete distribution of the polymer in the entire mould cavity is, however, often difficult, and accordingly this often results in so-called dry spots, i.e. areas with fibre material not being sufficiently impregnated with resin. Thus, dry spots are areas where the fibre material is not impregnated, and where there can be air pockets, which are difficult or impossible to remove by controlling the vacuum pressure and a possible overpressure at the inlet side. In vacuum infusion techniques employing a rigid mould part and a resilient mould part in the form of a vacuum bag, the dry spots can be repaired after the process of filling the mould by puncturing the bag in the respective location and by drawing out air for example by means of a syringe needle. Liquid polymer can optionally be injected in the respective location, and this can for example be done by means of a syringe needle as well. This is a time-consuming and tiresome process. In the case of large mould parts, staff have to stand on the vacuum bag. This is not desirable, especially not when the polymer has not hardened, as it can result in deformations in the inserted fibre material and thus in a local weakening of the structure, which can cause for instance buckling effects.

In most cases, the polymer or resin applied is polyester, vinyl ester or epoxy, but may also be PUR or pDCPD, and the fibre reinforcement is most often based on glass fibres or carbon fibres or even hybrids thereof. Epoxies have advantages with respect to various properties, such as shrinkage during curing (which in some circumstances may lead to less wrinkles in the laminate), electrical properties and mechanical and fatigue strengths. Polyester and vinyl esters have the advantage that they provide better bonding properties to gelcoats. Thereby, a gelcoat may be applied to the outer surface of the shell during the manufacturing of the shell by applying a gelcoat to the mould before fibre reinforcement material is arranged in the mould. Thus, various post-moulding operations, such as painting the blade, may be avoided. Further, polyesters and vinyl esters are cheaper than epoxies and further does not require external equipment to cure the resin. Consequently, the manufacturing process may be simplified, and costs may be lowered.

Often the composite structures comprise a core material covered with a fibre-reinforced material, such as one or more fibre-reinforced polymer layers. The core material can be used as a spacer between such layers to form a sandwich structure and is typically made of a rigid, lightweight material in order to reduce the weight of the composite structure. In order to ensure an efficient distribution of the liquid resin during the impregnation process, the core material may be provided with a resin distribution network, for instance by providing channels or grooves in the surface of the core material.

Resin transfer moulding (RTM) is a manufacturing method, which is similar to VARTM. In RTM, the liquid resin is not drawn into the mould cavity due to a vacuum generated in the mould cavity. Instead, the liquid resin is forced into the mould cavity via an overpressure at the inlet side.

Prepreg moulding is a method in which reinforcement fibres are pre-impregnated with a pre-catalysed resin. The resin is typically solid or near-solid at room temperature. The prepregs are arranged by hand or machine onto a mould surface, vacuum bagged and then heated to a temperature, where the resin is allowed to reflow and eventually cured. This method has the main advantage that the resin content in the fibre material is accurately set beforehand. The prepregs are easy and clean to work with and make automation and labour saving feasible. The disadvantage with prepregs is that the material cost is higher than for non-impregnated fibres. Further, the core material needs to be made of a material which is able to withstand the process temperatures needed for bringing the resin to reflow. Prepreg moulding may be used both in connection with an RTM and a VARTM process.

Further, it is possible to manufacture hollow mouldings in one piece by use of outer mould parts and a mould core. Such a method is for instance described in EP 1 310 351 and may readily be combined with RTM, VARTM and prepreg moulding.

As for instance blades for wind turbines have become longer and larger in the course of time and may now be more than 100 meters long, the impregnation time in connection with manufacturing such blades has increased, because more fibre material has to be impregnated with polymer. Furthermore, the infusion process has become more complicated, as the impregnation of large shell members, such as blades, requires control of the flow fronts to avoid dry spots, said control may e.g. include a time-related control of inlet channels and vacuum channels. This increases the time required for drawing in or injecting polymer. As a result, the polymer has to stay liquid for a longer time, normally also resulting in an increase in the curing time.

It is also important to ensure that the resin is able to wet the entire fibre material. This has become increasingly important, because the load-carrying structure may comprise a large number of fibre mats or fabrics, e.g. with unidirectionally oriented fibres, that are compressed during the VARTM process. In order to ensure a flow through the stack of fibre layers and transverse to the fibre layers, flow-enhancing mats may be arranged in the stack. The flow-enhancing layers may be arranged e.g. as a lower flow-enhancing layer and/or as an intermediate flow-enhancing layer between layers of fibre reinforcement material. The flow-enhancing layers are often made of a meshed or woven biaxial structure made of glass fibres. However, the layers often have to be relatively thick in order to ensure the required flow in the transverse direction of the stacked fibre layers. This adds to the overall weight of the load-carrying structure and thereby the overall wind turbine blade, which in turn may increase loads to the wind turbine blade and wind turbine during later operation.

### SUMMARY OF THE INVENTION

It is an object of the invention to obtain a new precured fibrous strip, a new spar cap, a new method of manufacturing a spar cap for a wind turbine blade, and a new wind turbine blade, which overcome or ameliorate at least one of the disadvantages of the prior art or which provide a useful alternative.

According to a first aspect, this is obtained by a method of manufacturing a wind turbine blade part, such as a spar cap, by means of resin transfer moulding, preferably vacuum assisted resin transfer moulding, where fibre reinforcement material is impregnated with liquid resin in a mould cavity, wherein the mould cavity comprises a rigid mould part having a mould surface defining a surface of the wind turbine blade part, wherein the method comprises the steps of:
a) stacking a plurality of fibre reinforcement layers on the rigid mould part forming a fibre reinforcement stack,
b) providing at least one flow-enhancing mat in the fibre reinforcement stack,
c) sealing a second mould part, e.g. a vacuum bag, against the rigid mould part to form the mould cavity,
d) optionally evacuating the mould cavity,
e) supplying a resin to the mould cavity, and
f) curing or hardening the resin in order to form the wind turbine blade part;
wherein the at least one flow-enhancing mat has a longitudinal direction with a longitudinal extent between a first longitudinal end and a second longitudinal end, and a transverse direction with transverse extent between a first side and a second side, and wherein the flow-enhancing mat comprises:
fibre rovings arranged in parallel in a warp direction, and
a plurality of individual monofilaments that are arranged with a mutual inter-filament distance and oriented in a weft direction.

The fibre rovings are preferably arranged in warp strips having a warp strip width, the warp strips comprising: first warp strips that are woven in a first direction around the monofilaments, and second warp strips that are woven in an opposite, second direction around the monofilaments. Preferably, the first warp strips each comprise a plurality of parallelly extending first fibre rovings, and the second warp strips each comprise a plurality of parallelly extending second fibre rovings. The first and second warps strips are arranged in a consecutive pattern juxtaposed to each other.

It is recognised that the at least one flow-enhancing mat may be arranged anywhere in the stack, e.g. as a lower flow-enhancing mat, or as an intermediate flow-enhancing mat, or as an upper flow-enhancing mat, or a combination of those. The term “mat” defines a fabric that can be laid as a single structure. In other words, the fabric comprises both the fibre rovings and monofilaments in a single fabric that can be laid out together.

The design of the flow-enhancing layer ensures that the layer can be kept relative thin and have a relatively low overall weight while the in-plane flow is enhanced in particular in the direction of the monofilaments and through the reinforcement stack, because the monofilaments ensure that resin pathways are created near the monofilament, because the monofilament may substantially retain its cross-sectional shape while the resin is wetting the fibre reinforcement stack. Thereby, the increase in weight to the fibre reinforcement stack can be kept low, while ensuring that the fibre reinforcement stack is completely wetted. Further, the time to impregnate the fibre reinforcement stack with liquid resin may be lowered. Finally, the design ensures that the flow-enhancing mat may be arranged as a unitary structure, which simplifies the layup procedure.

As used herein, the term “flow-enhancing fabric mat” relates to a unitary mat that has a higher permeability with respect to the resin compared to the fibre reinforcement layer, e.g. for a comparable thickness, and which thus promotes or enhances the flow of resin through the thickness of the stacked fibre layers and/or in-plane in the stacked fibre layers.

According to a second aspect, the object is obtained by a spar cap manufactured according to the above method, and a spar cap for a wind turbine comprising a plurality of stacked fibre reinforcement layers forming a fibre reinforcement stack, and at least one flow-enhancing mat within the fibre reinforcement stack, wherein the plurality of stacked fibre reinforcement layers and the at least one flow-enhancing mat are embedded in a polymer matrix, wherein the at least one flow-enhancing mat has a longitudinal direction with a longitudinal extent between a first longitudinal end and a second longitudinal end, and a transverse direction with transverse extent between a first side and a second side, and wherein the flow-enhancing mat comprises: fibre rovings arranged in parallel in a warp direction, and a plurality of individual monofilaments that are arranged with a mutual inter-filament distance and oriented in a weft direction.

The fibre rovings are preferably arranged in warp strips having a warp strip width, the warp strips comprising: first warp strips that are woven in a first direction around the monofilaments, and second warp strips that are woven in an opposite, second direction around the monofilaments. Preferably, the first warp strips each comprise a plurality of parallelly extending first fibre rovings, and the second warp strips each comprise a plurality of parallelly extending second fibre rovings. The first and second warps strips are arranged in a consecutive pattern juxtaposed to each other.

According to a third aspect, the object is obtained by a flow-enhancing mat having a longitudinal direction with a longitudinal extent between a first longitudinal end and a second longitudinal end, and a transverse direction with transverse extent between a first side and a second side, wherein the flow-enhancing mat comprises: fibre rovings arranged in parallel in a warp direction, and a plurality of individual monofilaments that are arranged with a mutual inter-filament distance and oriented in a weft direction.

The fibre rovings are preferably arranged in warp strips having a warp strip width, the warp strips comprising: first warp strips that are woven in a first direction around the monofilaments, and second warp strips that are woven in an opposite, second direction around the monofilaments. Preferably, the first warp strips each comprise a plurality of parallelly extending first fibre rovings, and the second warp strips each comprise a plurality of parallelly extending second fibre rovings. The first and second warps strips are arranged in a consecutive pattern juxtaposed to each other.

In the following, preferred embodiments according to the above aspects are described. The various embodiments may be combined in any conceived combination.

Preferably, the monofilaments are substantially straight, whereas the rovings are arranged in a wavy pattern.

According to a preferred embodiment of the method, steps a) and b) are carried out by alternately stacking on the region mould part: i) a number of fibre reinforcement layers, and ii) a flow-enhancing mat, and repeating steps i) and ii) until a desired thickness of the fibre reinforcement stack is obtained.

It is clear that the flow-enhancing mat or mats comprise the aforementioned composition.

The fibre reinforcement layers are preferably glass fibre layers, carbon fibre layers, or hybrid reinforcement layers comprising both glass fibres and carbon fibres.

It is also clear that the fibre reinforcement layers in the wind turbine blade part may be unidirectionally oriented fibres and e.g. be provided in form of fibre tows or rovings. The unidirectionally oriented fibres may for instance be oriented substantially in a spanwise direction of the spar cap of a wind turbine blade.

In another preferred embodiment, the warp direction is oriented in the longitudinal direction of the mat and the weft direction is oriented in the transverse direction of the mat. Thereby, it is ensured that the resin flow is enhanced in a transverse direction of the flow-enhancing mat.

In yet another preferred embodiment, the flow-enhancing mat or mats are arranged so that the fibre rovings are oriented substantially in a longitudinal direction of the wind turbine blade part and the monofilaments are oriented substantially in a transverse direction of the wind turbine blade part. The roving may for instance be arranged substantially in a spanwise direction and the monofilaments substantially in a chordwise direction. Thus, the flow is enhanced in the transverse direction, i.e. substantially in the chordwise direction of the wind turbine blade part.

In a preferred embodiment, the at least one flow-enhancing mat comprises a stabilising material arranged at the first side and/or the second side of the mat. The stabilising material may be at least one of a leno weave, gauze weave, cross weave, a stitch yarn, a melted thermoplastic yarn or the like. The stabilising material ensures that the flow-enhancing mat is stable at the edges or sides such that distortions or wrinkles are prevented during layup of the mat.

In one embodiment, the fibre rovings are arranged in warp strips having a warp strip width. The warp strip width is preferably between 1000 micrometres and 5000 micrometres, preferably between 1500 micrometres and 3500 micrometres, even more preferably between 2000 micrometres and 2500 micrometres.

The mutual inter-filament distance is preferably between 1000 micrometres and 5000 micrometres, preferably between 1500 micrometres and 3500 micrometres, even more preferably between 2000 micrometres and 2500 micrometres. This ensures an acceptable trade-off between a low waviness and enhanced flow properties for the mat.

The fibre rovings in a warp strip of the flow-enhancing mat may advantageously be arranged in a single layer. This ensures a small thickness and low weight, while the mono-filament ensures the flow properties.

The fibre rovings of the mat are preferably glass fibre rovings. The monofilaments are preferably made of a synthetic material, e.g. glass or a polymer material, e.g. polyester or polyethylenterephthalat (PET). The important feature is that the monofilament may substantially keep its cross-sectional shape while the resin is wetting the material.

In a preferred embodiment, the average filament diameter of the fibre rovings are at most 50 micrometres, preferably at most 25 micrometres, even more preferably at most 20 micrometres.

In another preferred embodiment, the average diameter of the monofilaments is between 100 and 1000 micrometres, preferably between 150 and 500 micrometres, e.g. around 250 micrometres or 350 micrometres.

The weight of the mat is preferably between 50 and 500 g/m2, preferably between 75 and 250 g/m2, and more preferably between 100 and 200 g/m2.

The weight of the fibre rovings in the mat is between 50 and 400 g/m2, preferably between 60 and 200 g/m2, and more preferably between 75 and 150 g/m2. The nominal linear roving weight of the fibre rovings may e.g. be between 100 and 500 tex, e.g. around 200 tex.

The weight of the monofilaments in the mat is between 10 and 100 g/m2, preferably between 15 and 80 g/m2, and more preferably between 20 and 75 g/m2. The nominal linear filament weight of the monofilament may be between 10 and 300 tex, e.g. be around 65 tex or around 130 tex. But it could also be lower, e.g. for a hollow monofilament.

The mats may also be provided with a colour pilot yarn having a non-conductive pigment and extending parallel to one or both of the sides of the mat, e.g. with a spacing or spacings of 5-15 mm from the first side and/or the second side.

### BRIEF DESCRIPTION OF THE FIGURES

The invention is explained in detail below with reference to embodiments shown in the drawings, in which

FIG. 1 shows a wind turbine,

FIG. 2 shows a schematic view of a wind turbine blade,

FIG. 3 shows a schematic view of a cross-section of a wind turbine blade,

FIG. 4 shows a schematic view of a cross-section of a fibre reinforcement stack in a spar cap for a wind turbine blade,

FIG. 5 shows a schematic top view of a flow-enhancing mat according to the invention, and

FIG. 6 shows a schematic side view of the flow-enhancing mat according to the invention.

### DETAILED DESCRIPTION OF THE INVENTION

In the following, a number of exemplary embodiments are described in order to understand the invention.

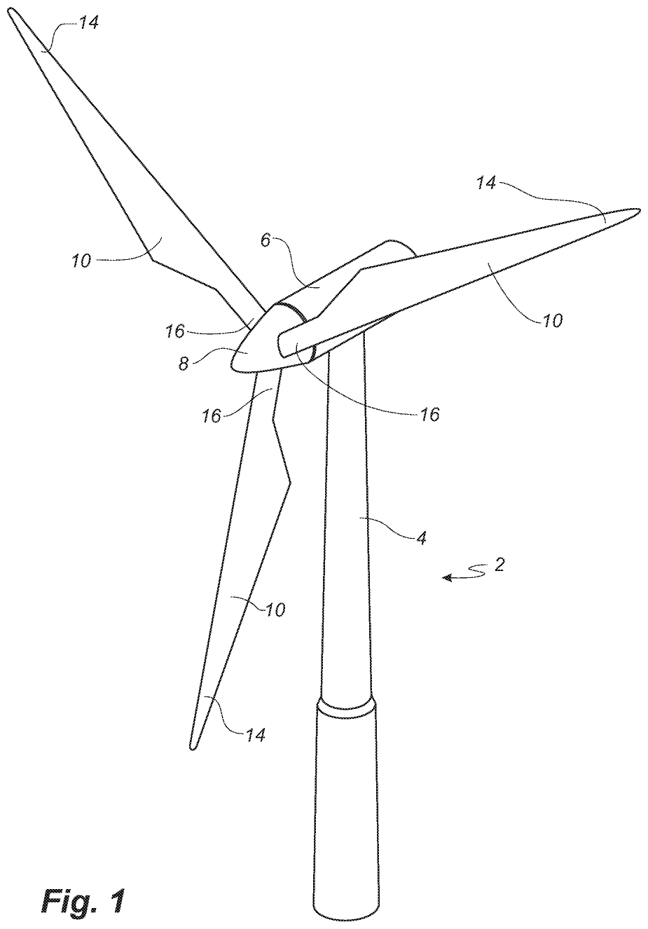

FIG. 1 illustrates a conventional modern upwind wind turbine according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8.

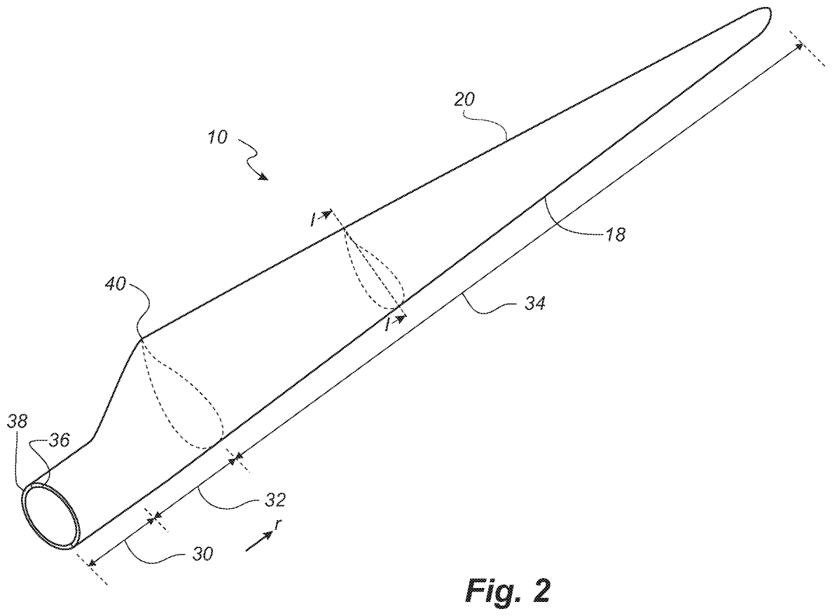

FIG. 2 shows a schematic view of a first embodiment of a wind turbine blade 10 disclosure. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10 when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub.

The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The blade is typically made from a pressure side shell part 36 and a suction side shell part 38 that are glued to each other along bond lines at the leading edge 18 and the trailing edge 20 of the blade.

In the following, the invention is explained with respect to the manufacture of the pressure side shell part 36 or suction side shell part 38.

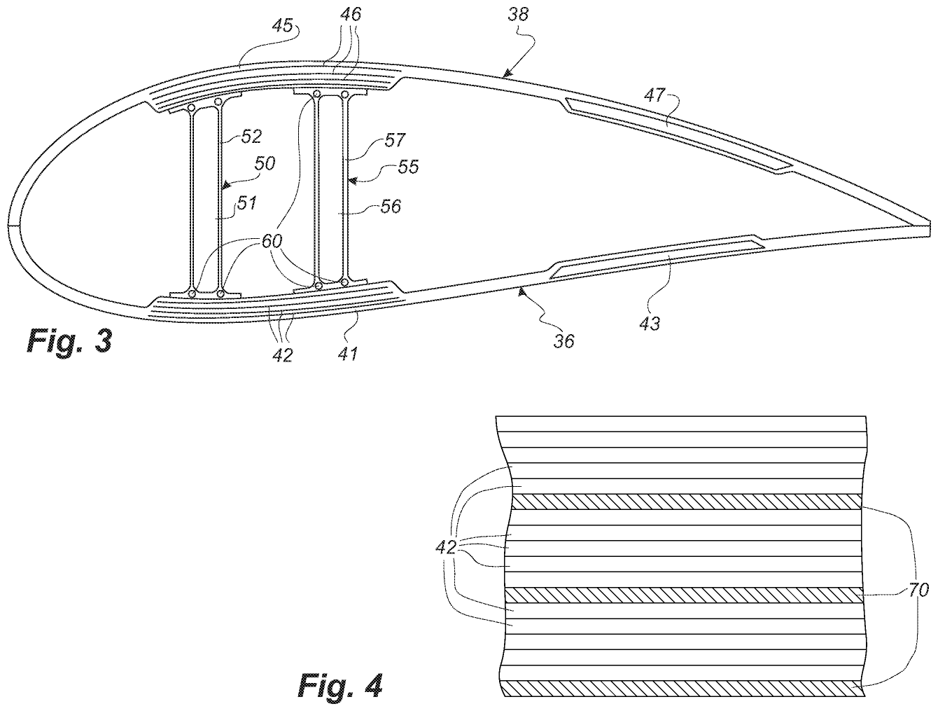

FIG. 3 shows a schematic view of a cross-section of the blade along the line I-I shown in FIG. 2. As previously mentioned, the blade 10 comprises a pressure side shell part 36 and a suction side shell part 38. The pressure side shell part 36 comprises a spar cap 41, also called a main laminate, which constitutes a load-bearing part of the pressure side shell part 36. The spar cap 41 comprises a plurality of fibre layers 42 mainly comprising unidirectional fibres aligned along the longitudinal direction of the blade in order to provide stiffness to the blade. The suction side shell part 38 also comprises a spar cap 45 comprising a plurality of fibre layers 46. The pressure side shell part 38 may also comprise a sandwich core material 43 typically made of balsawood or foamed polymer and sandwiched between a number of fibre-reinforced skin layers. The sandwich core material 43 is used to provide stiffness to the shell in order to ensure that the shell substantially maintains its aerodynamic profile during rotation of the blade. Similarly, the suction side shell part 38 may also comprise a sandwich core material 47.

The spar cap 41 of the pressure side shell part 36 and the spar cap 45 of the suction side shell part 38 are connected via a first shear web 50 and a second shear web 55. The shear webs 50, 55 are in the shown embodiment shaped as substantially I-shaped webs. The first shear web 50 comprises a shear web body and two web foot flanges. The shear web body comprises a sandwich core material 51, such as balsawood or foamed polymer, covered by a number of skin layers 52 made of a number of fibre layers. The second shear web 55 has a similar design with a shear web body and two web foot flanges, the shear web body comprising a sandwich core material 56 covered by a number of skin layers 57 made of a number of fibre layers. The sandwich core material 51, 56 of the two shear webs 50, 55 may be chamfered near the flanges in order to transfer loads from the webs 50, 55 to the main laminates 41, 45 without the risk of failure and fractures in the joints between the shear web body and web foot flange. However, such a design will normally lead to resin rich areas in the joint areas between the legs and the flanges. Further, such resin rich area may comprise burned resin due to high exothermic peeks during the curing process of the resin, which in turn may lead to mechanical weak points.

In order to compensate for this, a number of filler ropes 60 comprising glass fibres may be arranged at these joint areas. Further, such ropes 60 will also facilitate transferring loads from the skin layers of the shear web body to the flanges. However, according to the invention, alternative constructional designs are possible.

The blade shells 36, 38 may comprise further fibre reinforcement at the leading edge and the trailing edge. Typically, the shell parts 36, 38 are bonded to each other via glue flanges in which additional filler ropes may be used (not shown). Additionally, very long blades may comprise sectional parts with additional spar caps, which are connected via one or more additional shear webs.

FIG. 4 schematically shows a cross-sectional view of an exemplary layup or arrangement of layers for the manufacture of a spar cap for a wind turbine blade. The exemplary layup shows a fibre reinforcement stack that alternates a plurality of fibre reinforcement layers 42 with a flow-enhancing layer 70. The fibre reinforcement layers are preferably glass fibre layers, carbon fibre layers, or hybrid reinforcement layers comprising both glass fibres and carbon fibres, and preferably comprises unidirectionally oriented fibres, e.g. provided in form of fibre tows or rovings. The unidirectionally oriented fibres are preferably oriented substantially in a spanwise direction of the spar cap 41 of a wind turbine blade.

The fibre reinforcement layers are stacked on a rigid mould part (not shown) that has a mould surface defining a surface of the wind turbine blade part being manufactured, e.g. the blade shell 36 comprising the spar cap 41. Further, a vacuum bag (not shown) is sealed against the rigid mould part thus forming a mould cavity between the rigid mould part and vacuum bag. Then the mould cavity may be evacuated and resin is supplied to the cavity. After the fibre reinforcement material is fully wetted, the resin is cured in order to form the finish wind turbine blade part.

It is recognised that the flow-enhancing mat 70 may be arranged anywhere in the stack, e.g. as a lower flow-enhancing mat, or as an intermediate flow-enhancing mat, or as an upper flow-enhancing mat, or a combination of those.

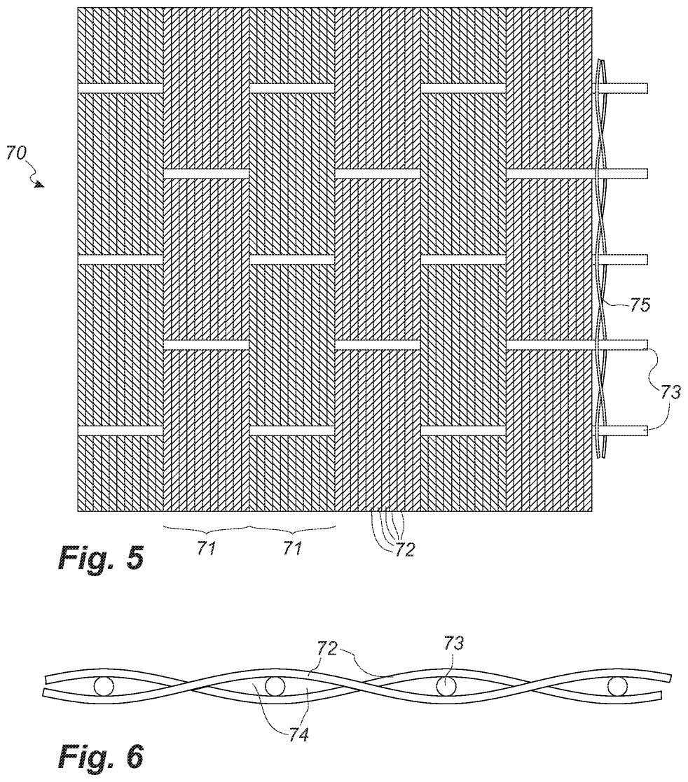

The design of the flow-enhancing mat 70 is shown in greater detail in FIGS. 5 and 6. The flow-enhancing mat 70 has a longitudinal direction with a longitudinal extent between a first longitudinal end and a second longitudinal end, and a transverse direction with transverse extent between a first side and a second side. The flow-enhancing mat 70 comprises fibre rovings 72 arranged in parallel in a warp direction, and a plurality of individual monofilaments 73 that are arranged with a mutual inter-filament distance and oriented in a weft direction. The fibre rovings are preferably made of glass fibres, whereas the monofilaments are preferably made of a polymer material, e.g. polyester or polyethylenterephthalat (PET). The monofilaments may be made of a material that dissolves into the resin that is supplied to the mould cavity.

As shown in FIG. 5, the fibre rovings 72 are preferably arranged in warp strips 71 having a warp strip width, wherein first warp strips are woven in a first direction around the monofilaments 73 and second warp strips woven in an opposite, second direction around the monofilaments 73. As shown in FIG. 5, the first warp strips preferably each comprise a plurality of parallelly extending first fibre rovings, and the second warp strips preferably each comprise a plurality of parallelly extending second fibre rovings. The first warp strips and second warp strips are preferably arranged in a consecutive pattern juxtaposed to each other, i.e. alternating juxtaposed first and second warp strips. Preferably, the monofilaments are substantially straight, whereas the rovings are arranged in a wavy pattern as shown in FIG. 6.

FIG. 6 shows a side view of the flow-enhancing mat, and it is seen that the woven pattern creates voids 74 near the monofilaments 73, through which the resin can more easily propagate and create a flow in the weft direction as well as through the thickness of the fibre reinforcement stack.

The design of the flow-enhancing layer ensures that the layer can be kept relative thin and have a relatively low overall weight while the in-plane flow is enhanced in particular in the direction of the monofilaments and through the reinforcement stack. Thereby, the increase in weight to the fibre reinforcement stack can be kept low, while ensuring that the fibre reinforcement stack is completely wetted. Further, the time to impregnate the fibre reinforcement stack with liquid resin may be lowered. Finally, the design ensures that the flow-enhancing mat may be arranged as a unitary structure, which simplifies the layup procedure.

Preferably, the flow-enhancing mat or mats are arranged so that the fibre rovings 72 are oriented substantially in the longitudinal direction of the wind turbine blade part (e.g. substantially in a spanwise direction of the spar cap 41) and the monofilaments 73 are oriented substantially in a transverse direction of the wind turbine blade part (e.g. substantially in a transverse or chordwise direction of the spar cap 41).

In addition, the flow-enhancing mat 70 comprises a stabilising material 75 arranged at the first side and/or the second side of the mat 70. The stabilising material may be at least one of a leno weave, gauze weave, cross weave, a stitch yarn, a melted thermoplastic yarn or the like. The stabilising material ensures that the flow-enhancing mat is stable at the edges or sides such that distortions or wrinkles are prevented during layup of the mat.

The mats may also be provided with a colour pilot yarn (not shown) having a non-conductive pigment and extending parallel to one or both of the sides of the mat, e.g. with a spacing or spacings of 5-15 mm from the first side and/or the second side. Such pilot yarn may be utilised to verify that the mat 70 is arranged correctly in the layup.

The warp strip width is preferably between 1000 micrometres and 5000 micrometres, preferably between 1500 micrometres and 3500 micrometres, even more preferably between 2000 micrometres and 2500 micrometres. Likewise, the mutual inter-filament distance is preferably between 1000 micrometres and 5000 micrometres, preferably between 1500 micrometres and 3500 micrometres, even more preferably between 2000 micrometres and 2500 micrometres. This ensures an acceptable trade-off between a low waviness and enhanced flow properties for the mat 70.

The fibre rovings of a warp strip 71 of the flow-enhancing mat 70 may as shown in FIG. 6 be arranged in a single layer. This ensures a small thickness and low weight, while the monofilament 73 ensures the flow properties. The average filament diameter of the fibre rovings 72 are preferably at most 50 micrometres, preferably at most 25 micrometres, even more preferably at most 20 micrometres.

The average diameter of the monofilaments 73 is between 100 and 1000 micrometres, preferably between 150 and 500 micrometres. The average diameter of the monofilaments 73 may for instance be around 250 micrometres or 350 micrometres.

The weight of the mat 70 is preferably between 50 and 500 g/m2, preferably between 75 and 250 g/m2, and more preferably between 100 and 200 g/m2. The weight of the fibre rovings in the mat is preferably between 50 and 400 g/m2, preferably between 60 and 200 g/m2, and more preferably between 75 and 150 g/m2. The nominal linear roving weight of the fibre rovings may e.g. be 200 tex. The weight of the monofilaments 73 in the mat is between 10 and 100 g/m2, preferably between 15 and 80 g/m2, and more preferably between 20 and 75 g/m2. The nominal linear filament weight of the monofilament may e.g. be 65 or 130 tex.

While the invention has been explained in relation to the layup in a main laminate or spar cap, it is recognised that the flow-enhancing mat may also be used elsewhere in the wind turbine blade, e.g. at the (not shown) reinforcements at the leading edge and trailing edge of the blade. The flow-enhancing mats may also be used at the sandwich construction parts of the blade. Further, they may be used at the root of the blade. Further, it is recognised that the flow-enhancing mat may be oriented in the direction of the required flow. In the root section for instance, it is recognised that the flow-enhancing mat may be oriented in the transverse direction in order to ensure an improved flow in the spanwise direction of the wind turbine blade. Finally, while the invention has been explained in relation to dry fibre reinforcement layers, it is clear that prepregs or precured elements, such as pultrusions, also may be used.

Exemplary embodiments of the present disclosure are set out in the following items:
1. A method of manufacturing a wind turbine blade part, such as a spar cap, by means of resin transfer moulding, preferably vacuum assisted resin transfer moulding, where fibre reinforcement material is impregnated with liquid resin in a mould cavity, wherein the mould cavity comprises a rigid mould part having a mould surface defining a surface of the wind turbine blade part, wherein the method comprises the steps of:
   a) stacking a plurality of fibre reinforcement layers on the rigid mould part forming a fibre reinforcement stack,
   b) providing at least one flow-enhancing mat in the fibre reinforcement stack,
   c) sealing a second mould part, e.g. a vacuum bag, against the rigid mould part to form the mould cavity,
   d) optionally evacuating the mould cavity,
   e) supplying a resin to the mould cavity, and
   f) curing or hardening the resin in order to form the wind turbine blade part;
wherein the at least one flow-enhancing mat has a longitudinal direction with a longitudinal extent between a first longitudinal end and a second longitudinal end, and a transverse direction with transverse extent between a first side and a second side, and wherein the flow-enhancing mat comprises:
   fibre rovings arranged in parallel in a warp direction, and
   a plurality of individual monofilaments that are arranged with a mutual inter-filament distance and oriented in a weft direction.
2. A method according to item 1, wherein steps a) and b) are carried out by alternately stacking on the region mould part:
   i) a number of fibre reinforcement layers, and
   ii) a flow-enhancing mat, and repeating steps i) and ii) until a desired thickness of the fibre reinforcement stack is obtained.
3. A method according to item 1 or 2, wherein the warp direction is oriented in the longitudinal direction of the mat and the weft direction is oriented in the transverse direction of the mat.
4. A method according to item 3, wherein the flow-enhancing mat or mats are arranged so that the fibre rovings are oriented substantially in a longitudinal direction of the wind turbine blade part and the monofilaments are oriented substantially in a transverse direction of the wind turbine blade part.
5. The method according to any of items 1-4, wherein the at least one flow-enhancing mat comprises a stabilising material arranged at the first side and/or the second side of the mat.
6. The method according to item 5, wherein the stabilising material is at least one of a leno weave, gauze weave, cross weave, a stitch yarn, a melted thermoplastic yarn or the like.
7. The method according to any of items 1-6, wherein the fibre rovings are arranged in warp strips having a warp strip width.
8. The method according to item 7, wherein the warp strip width is between 1000 micrometres and 5000 micrometres, preferably between 1500 micrometres and 3500 micrometres, even more preferably between 2000 micrometres and 2500 micrometres.
9. The method according to any of items 1-8, wherein the mutual inter-filament distance is between 1000 micrometres and 5000 micrometres, preferably between 1500 micrometres and 3500 micrometres, even more preferably between 2000 micrometres and 2500 micrometres.
10. The method according to any of items 1-9, wherein the fibre rovings of a warp strip in the flow-enhancing mat are arranged in a single layer.
11. The method according to any of items 1-10, wherein the fibre rovings are glass fibre rovings.
12. The method according to any of items 1-11, wherein the monofilaments are made of a polymer material, e.g. polyester or polyethylenterephthalat (PET).
13. The method according to any of items 1-12, wherein the average filament diameter of the fibre rovings are at most 50 micrometres, preferably at most 25 micrometres, even more preferably at most 20 micrometres.
14. The method according to any of items 1-13, wherein the average diameter of the monofilaments is between 100 and 1000 micrometres, preferably between 150 and 500 micrometres, e.g. around 250 micrometres or 350 micrometres.
15. The method according to any of items 1-14, wherein the weight of the mat is between 50 and 500 g/m2, preferably between 75 and 250 g/m2, and more preferably between 100 and 200 g/m2.
16. The method according to any of items 1-15, wherein the weight of the fibre rovings in the mat is between 50 and 400 g/m2, preferably between 60 and 200 g/m2, and more preferably between 75 and 150 g/m2.
17. The method according to any of items 1-16, wherein the weight of the monofilaments in the mat is between 10 and 100 g/m2, preferably between 15 and 80 g/m2, and more preferably between 20 and 75 g/m2.
18. The method according to any of items 1-17, wherein the fibre rovings are arranged in warp strips having a warp strip width, the warp strips comprising:
   first warp strips that are woven in a first direction around the monofilaments, and
   second warp strips that are woven in an opposite, second direction around the monofilaments.
19. The method according to item 18, wherein
   the first warp strips each comprise a plurality of parallelly extending first fibre rovings, and
   the second warp strips each comprise a plurality of parallelly extending second fibre rovings.
20. A spar cap for a wind turbine manufactured according to any of items 1-19.
21. A spar cap for a wind turbine comprising a plurality of stacked fibre reinforcement layers forming a fibre reinforcement stack, and at least one flow-enhancing mat within the fibre reinforcement stack, wherein the plurality of stacked fibre reinforcement layers and the at least one flow-enhancing mat are embedded in a polymer matrix,
   wherein the at least one flow-enhancing mat has a longitudinal direction with a longitudinal extent between a first longitudinal end and a second longitudinal end, and a transverse direction with transverse extent between a first side and a second side, and wherein the flow-enhancing mat comprises:
   fibre rovings arranged in parallel in a warp direction, and
   a plurality of individual monofilaments that are arranged with a mutual inter-filament distance and oriented in a weft direction.
22. A flow-enhancing mat for use in a method of manufacturing a wind turbine blade part, wherein the flow-enhancing mat has a longitudinal direction with a longitudinal extent between a first longitudinal end and a second longitudinal end, and a transverse direction with transverse extent between a first side and a second side, wherein the flow-enhancing mat comprises:
   fibre rovings arranged in parallel in a warp direction, and
   a plurality of individual monofilaments that are arranged with a mutual inter-filament distance and oriented in a weft direction.
23. The flow-enhancing mat according to item 22, wherein the warp direction is oriented in the longitudinal direction and the weft direction is oriented in the transverse direction.
24. The flow-enhancing mat according to any of items 22-23, wherein a stabilising material is arranged at the first side and/or the second side of the mat, e.g. wherein the stabilising material is at least one of a leno weave, gauze weave, cross weave, a stitch yarn, a melted thermoplastic yarn or the like.
25. The flow-enhancing mat according to any of items 22-24, wherein the fibre rovings are arranged in warp strips having a warp strip width, e.g. wherein the warp strip width is between 1000 micrometres and 5000 micrometres, preferably between 1500 micrometres and 3500 micrometres, even more preferably between 2000 micrometres and 2500 micrometres.
26. The flow-enhancing mat according to any of items 22-25, wherein the mutual inter-filament distance is between 1000 micrometres and 5000 micrometres, preferably between 1500 micrometres and 3500 micrometres, even more preferably between 2000 micrometres and 2500 micrometres.
27. The flow-enhancing mat according to any of items 22-26, wherein the fibre rovings are glass fibre rovings, and/or wherein the monofilaments are made of a polymer material, e.g. polyester or polyethylenterephthalat (PET).
28. The flow-enhancing mat according to any of items 22-27, wherein the fibre rovings are arranged in warp strips having a warp strip width, the warp strips comprising:
   first warp strips that are woven in a first direction around the monofilaments, and
   second warp strips that are woven in an opposite, second direction around the monofilaments.
29. The flow-enhancing mat according to item 28, wherein
   the first warp strips each comprise a plurality of parallelly extending first fibre rovings, and
   the second warp strips each comprise a plurality of parallelly extending second fibre rovings.

### LIST OF REFERENCE NUMERALS

2 wind turbine
4 tower
6 nacelle
8 hub
10 blade
14 blade tip
16 blade root
18 leading edge
20 trailing edge
22 pitch axis
30 root region
32 transition region
34 airfoil region
36 pressure side shell
38 suction side shell
40 shoulder
41 load-carrying structure/spar cap
42 fibre reinforcement layers
43 sandwich core material
45 load-carrying structure/spar cap
46 fibre reinforcement layers
47 sandwich core material
50 first shear web
51 sandwich core material
52 skin layers
55 first shear web
56 sandwich core material
57 skin layers
60 filler robes
70 flow-enhancing layer
71 warp strip
72 rovings
73 monofilament
74 void
75 stabilising material

1-25. (canceled)

26. A method of manufacturing a wind turbine blade part, such as a spar cap, by means of resin transfer moulding, preferably vacuum assisted resin transfer moulding, where fibre reinforcement material is impregnated with liquid resin in a mould cavity, wherein the mould cavity comprises a rigid mould part having a mould surface defining a surface of the wind turbine blade part, wherein the method comprises the steps of:
a) stacking a plurality of fibre reinforcement layers on the rigid mould part forming a fibre reinforcement stack,
b) providing at least one flow-enhancing mat in the fibre reinforcement stack,
c) sealing a second mould part, e.g. a vacuum bag, against the rigid mould part to form the mould cavity,
d) optionally evacuating the mould cavity,
e) supplying a resin to the mould cavity, and
f) curing or hardening the resin in order to form the wind turbine blade part;
wherein the at least one flow-enhancing mat has a longitudinal direction with a longitudinal extent between a first longitudinal end and a second longitudinal end, and a transverse direction with transverse extent between a first side and a second side, and wherein the flow-enhancing mat comprises:
fibre rovings arranged in parallel in a warp direction, and
a plurality of individual monofilaments that are arranged with a mutual inter-filament distance and oriented in a weft direction.

27. A method according to claim 26, wherein steps a) and b) are carried out by alternately stacking on the region mould part:
i) a number of fibre reinforcement layers, and
ii) a flow-enhancing mat,
and repeating steps i) and ii) until a desired thickness of the fibre reinforcement stack is obtained.

28. A method according to claim 26, wherein the warp direction is oriented in the longitudinal direction of the mat and the weft direction is oriented in the transverse direction of the mat.

29. A method according to claim 28, wherein the flow-enhancing mat or mats are arranged so that the fibre rovings are oriented substantially in a longitudinal direction of the wind turbine blade part and the monofilaments are oriented substantially in a transverse direction of the wind turbine blade part.

30. The method according to claim 26, wherein the fibre rovings are arranged in warp strips having a warp strip width.

31. The method according to claim 26, wherein the fibre rovings of a warp strip in the flow-enhancing mat are arranged in a single layer.

32. The method according to claim 26, wherein the fibre rovings are glass fibre rovings.

33. The method according to claim 26, wherein the average filament diameter of the fibre rovings are at most 50 micrometres.

34. The method according to claim 26, wherein the average diameter of the monofilaments is between 100 and 1000 micrometres.

35. The method according to claim 26, wherein the weight of the mat is between 50 and 500 g/m2.

36. The method according to claim 26, wherein the weight of the fibre rovings in the mat is between 50 and 400 g/m2.

37. The method according to claim 26, wherein the weight of the monofilaments in the mat is between 10 and 100 g/m2.

38. A spar cap for a wind turbine manufactured according to claim 26.

39. A spar cap for a wind turbine comprising a plurality of stacked fibre reinforcement layers forming a fibre reinforcement stack, and at least one flow-enhancing mat within the fibre reinforcement stack, wherein the plurality of stacked fibre reinforcement layers and the at least one flow-enhancing mat are embedded in a polymer matrix,
wherein the at least one flow-enhancing mat has a longitudinal direction with a longitudinal extent between a first longitudinal end and a second longitudinal end, and a transverse direction with transverse extent between a first side and a second side, and wherein the flow-enhancing mat comprises:
fibre rovings arranged in parallel in a warp direction, and
a plurality of individual monofilaments that are arranged with a mutual inter-filament distance and oriented in a weft direction.

40. A flow-enhancing mat for use in a method of manufacturing a wind turbine blade part, wherein the flow-enhancing mat has a longitudinal direction with a longitudinal extent between a first longitudinal end and a second longitudinal end, and a transverse direction with transverse extent between a first side and a second side, wherein the flow-enhancing mat comprises:
fibre rovings arranged in parallel in a warp direction, and
a plurality of individual monofilaments that are arranged with a mutual inter-filament distance and oriented in a weft direction.

41. The flow-enhancing mat according to claim 40, wherein the warp direction is oriented in the longitudinal direction and the weft direction is oriented in the transverse direction.

42. The flow-enhancing mat according to claim 40, wherein a stabilising material is arranged at the first side and/or the second side of the mat, wherein the stabilising material is at least one of a leno weave, gauze weave, cross weave, a stitch yarn, a melted thermoplastic yarn or the like.

43. The flow-enhancing mat according claim 42, wherein the fibre rovings are arranged in warp strips having a warp strip width, e.g. wherein the warp strip width is between 1000 micrometres and 5000 micrometres.

44. The flow-enhancing mat according to claim 43, wherein the mutual inter-filament distance is between 1000 micrometres and 5000 micrometres.

45. The flow-enhancing mat according to claim 44, wherein the fibre rovings are glass fibre rovings, and/or wherein the monofilaments are made of a polymer material, e.g. polyester or polyethylenterephthalat (PET).
